(19) United States
(12) Patent Application Publication
(10) Pub. No.: US 2023/0195860 A1
(43) Pub. Date: Jun. 22, 2023

(54) SELECTIVE ON-DEMAND EXECUTION ENCRYPTION

(71) Applicant: International Business Machines Corporation, Armonk, NY (US)

(72) Inventors: Christopher Porter, Lawrenceville, GA (US); Hubertus Franke, Courtland Manor, NY (US); James Cadden, Medford, MA (US)

(21) Appl. No.: 17/645,084

(22) Filed: Dec. 20, 2021

(51) Int. Cl. G06F 21/12; G06F 21/60

(52) U.S. Cl. CPC G06F 21/12; G06F 21/602

(57) ABSTRACT

One or more embodiments herein relate to a process to dynamically decrypt code of a software. A system can comprise a memory that stores computer executable components, and a processor that executes the computer executable components stored in the memory, wherein the computer executable components can comprise a decryption component that, in response to an indication being received that encrypted code of a code block is to be used, can temporarily decrypt the encrypted code of the code block into decrypted code for use of the decrypted code in an unencrypted state. In an embodiment, an encryption component can obtain and encrypt code of the code block at compile time of the code block to provide the encrypted code. In an embodiment, an encryption component can write a trigger marker into the encrypted code of the code block when encrypting code of the code block to provide the encrypted code.

### BACKGROUND

In the field of software security, gadget-based attacks can hijack a program, application or other type of software using code portions (also referred to as snippets) that can be found in standard binary execution instructions for the software. Targeted code additionally and/or alternatively can include shared library function code and/or any other code with low frequency of usage and/or low frequency of consistency checking. These gadget-based attacks can include return-oriented programming (ROP), call-oriented programming (COP) and/or jump-oriented programming (JOP).

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. One or more embodiments described herein can be employed to address one or more deficiencies in existing encryption and/or decryption techniques of software by providing triggered and temporary decryption of code. In one or more embodiments described herein, systems, computer-implemented methods, apparatuses and/or computer program products can facilitate a process to decrypt a code block at a page level, a function level or a basic block level of a software.

In accordance with an embodiment, a system can comprise a memory that stores computer executable components, and a processor that executes the computer executable components stored in the memory, wherein the computer executable components can comprise a decryption component that, in response to an indication being received that encrypted code of a code block is to be used, can temporarily decrypt the encrypted code of the code block into decrypted code for use of the decrypted code in an unencrypted state.

In accordance with another embodiment, a computer-implemented method can comprise temporarily decrypting, by a system operatively coupled to a processor, in response to an indication being received that encrypted code of a code block is to be used, the encrypted code of the code block into decrypted code for use of the decrypted code in an unencrypted state.

In accordance with yet another embodiment, a computer program product facilitating a process to dynamically decrypt code can comprise a computer readable storage medium having program instructions embodied therewith. The program instructions can be executable by a processor to cause the processor to temporarily decrypt, by the processor, in response to an indication being received that encrypted code of a code block is to be used, the encrypted code of the code block into decrypted code for use of the decrypted code in an unencrypted state.

### DESCRIPTION OF THE DRAWINGS

FIG. 1 illustrates a block diagram of an example, non-limiting system that can facilitate a process to encrypt and to temporarily decrypt code of a code block, in accordance with one or more embodiments described herein.

FIG. 2 illustrates a block diagram of another example, non-limiting system that can facilitate a process to encrypt and to temporarily decrypt code of a code block, in accordance with one or more embodiments described herein.

FIG. 3 illustrates a set of four schematic diagrams of one or more operations that can be performed by the non-limiting system of FIG. 2, in accordance with one or more embodiments described herein.

FIG. 4 illustrates a high-level schematic diagram of one or more operations that can be performed by the non-limiting system of FIG. 2, in accordance with one or more embodiments described herein.

FIG. 5 illustrates another high-level schematic diagram of one or more operations that can be performed by the non-limiting system of FIG. 2, in accordance with one or more embodiments described herein.

FIG. 6 illustrates a process flow for facilitating a process to encrypt and to temporarily decrypt code of a code block, in accordance with one or more embodiments described herein.

FIG. 7 illustrates another process flow for facilitating a process to encrypt and to temporarily decrypt code of a code block, in accordance with one or more embodiments described herein.

FIG. 8 illustrates a block diagram of an example, non-limiting, operating environment in which one or more embodiments described herein can be facilitated.

FIG. 9 illustrates a block diagram of an example, non-limiting, cloud computing environment in accordance with one or more embodiments described herein.

FIG. 10 illustrates a block diagram of example, non-limiting, abstraction model layers in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In one or more cases, a software attack can succeed with minimal effort, such as by stringing together a Turing-incomplete sequence of gadgets (e.g., ROP, COP and/or JOP, among others) to hijack a program and/or to otherwise carry out an attacker's mal-intended end(s). In one or more other cases, a more sophisticated attack can construct a Turing-complete program from the aforementioned gadgets to achieve a mal-intended end.

In one or more cases, software debloating can be employed to remove features that are not going to be used and thus are not built into the binary. Dynamic software debloating can be employed to remove code at load time and to add back such code dynamically when it is to be used. Nonetheless, the binary itself is not protected at rest, and an attack can be constructed a priori.

Further, memory encryption and/or a trusted execution environment can be employed to isolate a program's memory, such as running the programs in an encrypted virtual machine (VM). However, such program and its memory can be susceptible to faults and/or errors already within such program, while also employing significant overhead for operating using a VM.

In one or more cases, particularly with relation to cloud computing, when running containers natively and with limited overhead, runtime memory of such containers can be exposed to hypervisor escapes and/or to a bug in a program or other software itself.

Unfortunately, these attacks can be made easy by the end user or even by the software itself, such as where non-used code or very minimally used code (e.g., at a very low frequency of usage) is included in software, such as in the standard execution instructions thereof. In one or more other cases, such attacks can employ code of shared functions, such as shared library functions. Indeed, in some softwares, a majority of execution code and or shared library function code can be targetable, such as being not frequently reviewed, analyzed and/or otherwise checked for attack. This can be the case in domestic softwares, professional softwares and/or special-use softwares, such as for a particular industry, such as steel manufacturing and/or nuclear power generation. As such, depending on the use of the softwares, exacerbation of easy access to binary can be problematic.

That is, in general, unused code or less-frequently used and/or reviewed code can be an issue, particularly when such code remains accessible to an attacker and/or is not encrypted. Described herein are one or more embodiments of a system, computer-implemented method and/or computer program product that can account for one or more deficiencies of existing softwares and/or of existing techniques for encryption of code.

In general, the one or more embodiments can facilitate one or more operations, including, but not limited to, encryption of software code such as at compile time, maintaining the encryption at rest of the code, at runtime and/or on-demand decrypting one or more code blocks when such blocks are to be used, purging the decrypted code when not in use, and/or triggering the decryption. As used herein, the term can include source code, execution code and/or other code types.

One or more embodiments are now described with reference to the drawings, where like referenced numerals are used to refer to like elements throughout. As used herein, the terms “entity”, “requesting entity” and “user entity” can refer to a machine, device, component, hardware, software, smart device and/or human. In the following description, for purposes of explanation, numerous specific details are set forth in order to provide a more thorough understanding of the one or more embodiments. It is evident, however, in various cases, that the one or more embodiments can be practiced without these specific details.

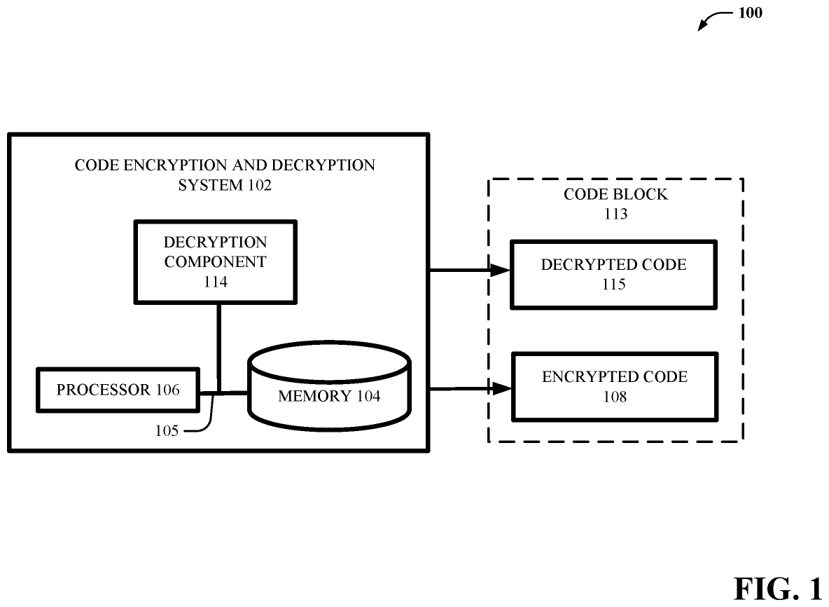

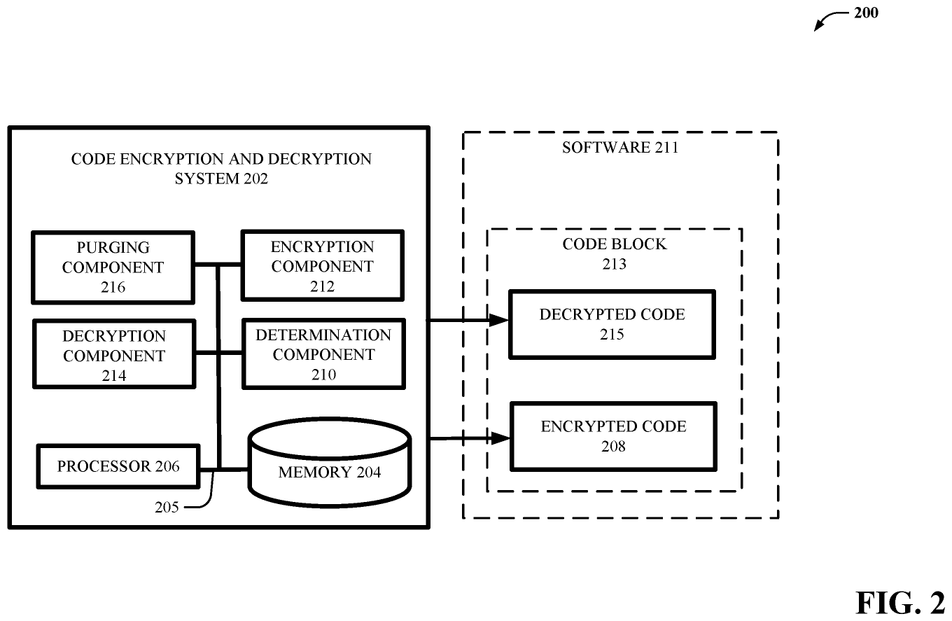

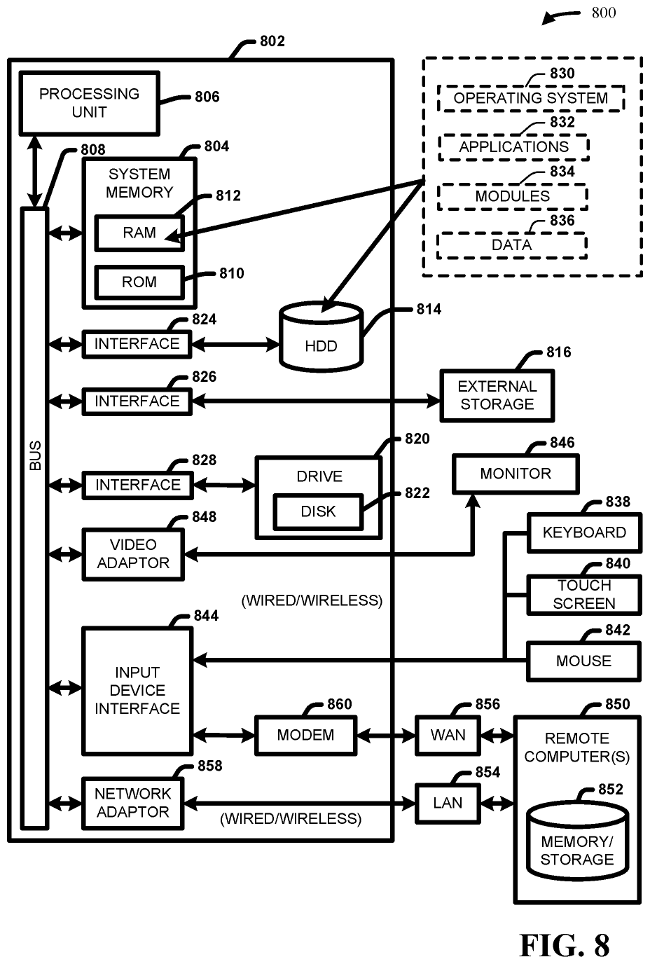

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100 and/or 200 as illustrated at FIGS. 1 and 2, and/or systems thereof, can further comprise, be associated with and/or be coupled to one or more computer and/or computing-based elements described herein with reference to an operating environment, such as the operating environment 800 illustrated at FIG. 8. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning first generally to FIG. 1, one or more embodiments described herein can include one or more devices, systems and/or apparatuses that can facilitate encryption and/or decryption of code of a code block. For example, FIG. 1 illustrates a block diagram of an example, non-limiting system 100 that can employ a decryption marker, temporary decryption and dynamic interception to facilitate use of code of the code block in a temporary decrypted state.

At FIG. 1, illustrated is a block diagram of an example, non-limiting system 100 that can facilitate a process for augmenting an optimization model and/or for generating a decision policy, in accordance with one or more embodiments described herein. While referring here to one or more processes, facilitations and/or uses of the non-limiting system 100, description provided herein, both above and below, also can be relevant to one or more other non-limiting systems described herein, such as the non-limiting system 200, to be described below in detail.

As illustrated at FIG. 1, the non-limiting system 100 can comprise a code encryption and decryption system 102. Code encryption and decryption system 102 can comprise one or more components, such as a memory 104, processor 106, bus 105 and/or decryption component 114. Generally, code encryption and decryption system 102 can facilitate temporary decryption of all or a portion of code of a code block only in instances of use of the code, to thereby generally otherwise maintain encryption of the code, such as during code rest (e.g., when not in use).

The decryption component 114 generally can, in response to an indication being received that encrypted code of a code block is to be used, temporarily decrypt the encrypted code 108 of the code block 113 into decrypted code 115 for use of the decrypted code 115 in an unencrypted state. The indication can be provided by the software comprising the code block 113, the processor 106 and/or another component of the code encryption and decryption system 102, of the non-limiting system 100 and/or of any other external system communicatively connected to the non-limiting system 100. Use of the decrypted code 115 can be for any suitable purpose, such as execution of the software comprising the code block 113.

One or more aspects of a component (e.g., the decryption component 114) can be employed separately and/or in combination, such as employing one or more of a memory or a processor of a system that includes the component to thereby facilitate decryption of encrypted code 108 of the code block 113 into the decrypted code 115. That is, one or more components can employ the processor 106 and/or the memory 104. Additionally and/or alternatively, the processor 106 can execute one or more program instructions to cause the processor 106 to perform one or more operations by one or more components of the code encryption and decryption system 102.

Turning next to FIG. 2, the figure illustrates a diagram of an example, non-limiting system 200 that can facilitate a process for encrypting and/or temporarily decrypting code of a code block, where the decryption can be facilitated by a dynamic interception technique, in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

As illustrated, the non-limiting system 200 can comprise a code encryption and decryption system 202. Generally, the code encryption and decryption system 202 can facilitate encryption of code of a code block at encryption time of the code and/or code block, maintaining encryption of the encrypted code at rest, decrypting the code temporarily at one or more different granularities as the code is to be used, and/or purging of decrypted code after one or more used of the decrypted code, to maintain security of the code.

The code encryption and decryption system 202, as illustrated, can comprise any suitable type of component, machine, device, facility, apparatus and/or instrument that comprises a processor and/or can be capable of effective and/or operative communication with a wired and/or wireless network. All such embodiments are envisioned. For example, code encryption and decryption system 202 can comprise a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device and/or computing device. Likewise, the code encryption and decryption system 202 can be disposed and/or run at any suitable device, such as, but not limited to a server device, computing device, general-purpose computer, special-purpose computer, quantum computing device (e.g., a quantum computer), tablet computing device, handheld device, server class computing machine and/or database, laptop computer, notebook computer, desktop computer, cell phone, smart phone, consumer appliance and/or instrumentation, industrial and/or commercial device, digital assistant, multimedia Internet enabled phone, multimedia players and/or another type of device and/or computing device.

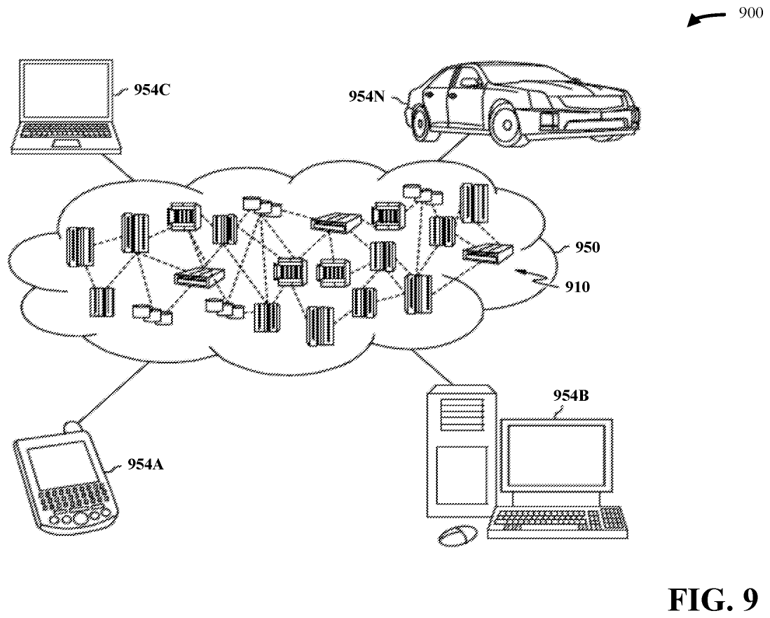

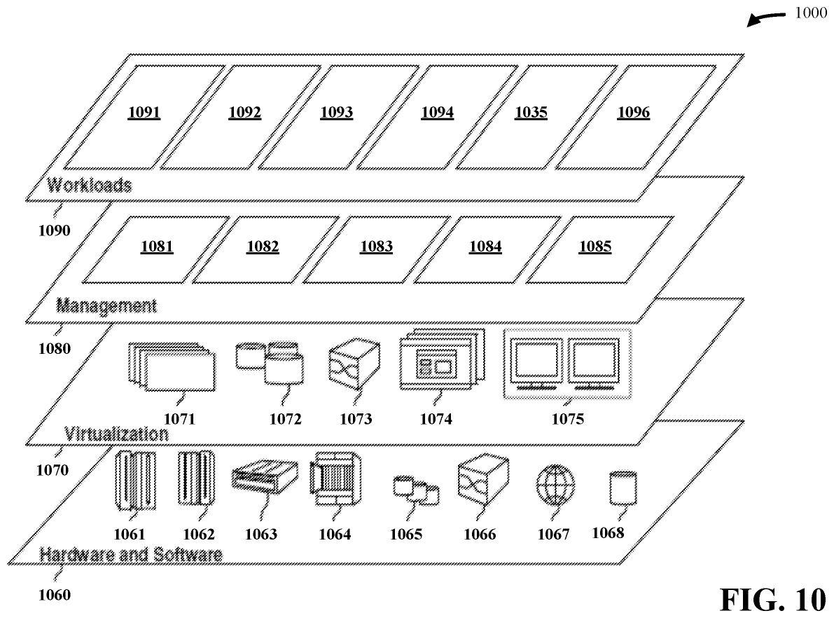

The code encryption and decryption system 202 can be associated with, such as accessible via, a cloud computing environment. For example, the code encryption and decryption system 202 can be associated with a cloud computing environment 950 described below with reference to FIG. 9 and/or with one or more functional abstraction layers described below with reference to FIG. 10 (e.g., hardware and software layer 1060, virtualization layer 1070, management layer 1080 and/or workloads layer 1090).

Operation of the non-limiting system 200 and/or of the code encryption and decryption system 202 is not limited to encryption and/or decryption of a single portion of code of a code block at a time. Rather, operation of the non-limiting system 200 and/or of the code encryption and decryption system 202 can be scalable. For example, the non-limiting system 200 and/or the code encryption and decryption system 202 can facilitate encryption and/or decryption of multiple portions of code of a code block or of plural code blocks at a time. use of a single or plural constraint inputs and/or output of a single or plural decision policies. Further, the non-limiting system 200 and/or the code encryption and decryption system 202 can both encryption and decryption operations simultaneously.

The code encryption and decryption system 202 can comprise a plurality of components. The components can include a memory 204, processor 206, bus 205, determination component 210, encryption component 212, decryption component 214, and/or purging component 216. Like the code encryption and decryption system 102, the code encryption and decryption system 202 can be operated to facilitate a process for encrypting and temporarily decrypting code of a code block on-demand, the thereby facilitate security of the code, such as at rest.

One or more communications between one or more components of the non-limiting system 200, and/or between an external system, such as comprising and/or facilitating access to any one or more softwares 211 and the non-limiting system 200, can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

Discussion now turns to the processor 206, memory 204 and bus 205 of the code encryption and decryption system 202.

For example, in one or more embodiments, code encryption and decryption system 202 can comprise a processor 206 (e.g., computer processing unit, microprocessor, classical processor, quantum processor and/or like processor). In one or more embodiments, a component associated with code encryption and decryption system 202, as described herein with or without reference to the one or more figures of the one or more embodiments, can comprise one or more computer and/or machine readable, writable and/or executable components and/or instructions that can be executed by processor 206 to facilitate performance of one or more processes defined by such component(s) and/or instruction(s). In one or more embodiments, the processor 206 can comprise determination component 210, encryption component 212, decryption component 214, and/or purging component 216.

In one or more embodiments, the code encryption and decryption system 202 can comprise a computer-readable memory 204 that can be operably connected to the processor 206. The memory 204 can store computer-executable instructions that, upon execution by the processor 206, can cause the processor 206 and/or one or more other components of the code encryption and decryption system 202 (e.g., determination component 210, encryption component 212, decryption component 214, and/or purging component 216) to perform one or more actions. In one or more embodiments, the memory 204 can store computer-executable components (e.g., determination component 210, encryption component 212, decryption component 214, and/or purging component 216).

Code encryption and decryption system 202 and/or a component thereof as described herein, can be communicatively, electrically, operatively, optically and/or otherwise coupled to one another via a bus 205 to perform functions of non-limiting system 200, code encryption and decryption system 202 and/or one or more components thereof and/or coupled therewith. Bus 205 can comprise one or more of a memory bus, memory controller, peripheral bus, external bus, local bus, quantum bus and/or another type of bus that can employ one or more bus architectures. One or more of these examples of bus 205 can be employed to implement one or more embodiments described herein.

In one or more embodiments, code encryption and decryption system 202 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical and/or quantum computing devices, communication devices and/or like devices), such as via a network. In one or more embodiments, one or more of the components of the non-limiting system 200 can reside in the cloud, and/or can reside locally in a local computing environment (e.g., at a specified location(s)).

In addition to the processor 206 and/or memory 204 described above, code encryption and decryption system 202 can comprise one or more computer and/or machine readable, writable and/or executable components and/or instructions that, when executed by processor 206, can facilitate performance of one or more operations defined by such component(s) and/or instruction(s).

Turning now to the determination component 210, the determination component can receive, download, transfer, upload and/or otherwise obtain a code block 213 and/or code of a code block 213 of a software 211. A software 211 can comprise and/or be comprised by a program, an application and/or the like. The software 211 and/or code block 213 thereof can be discoverable by and/or communicatively connected to the code encryption and decryption system 202 by any suitable means. While FIG. 2 illustrates the software 211 and code block 213 as being internal to the non-limiting system 200, the software 211 and/or code block 213 can be stored internal and/or external to the non-limiting system 200 in one or more embodiments.

The one or more code blocks 213 to be encrypted can be selectively determined by a user entity, for example, and/or by any suitable program controlling encryption of code of software of a system.

The code block 213 can represent any of a basic data block, function and/or page (e.g., system page) of a software. The code block 213 can comprise any suitable metadata and/or code in any suitable format, such as binary, text and/or the like.

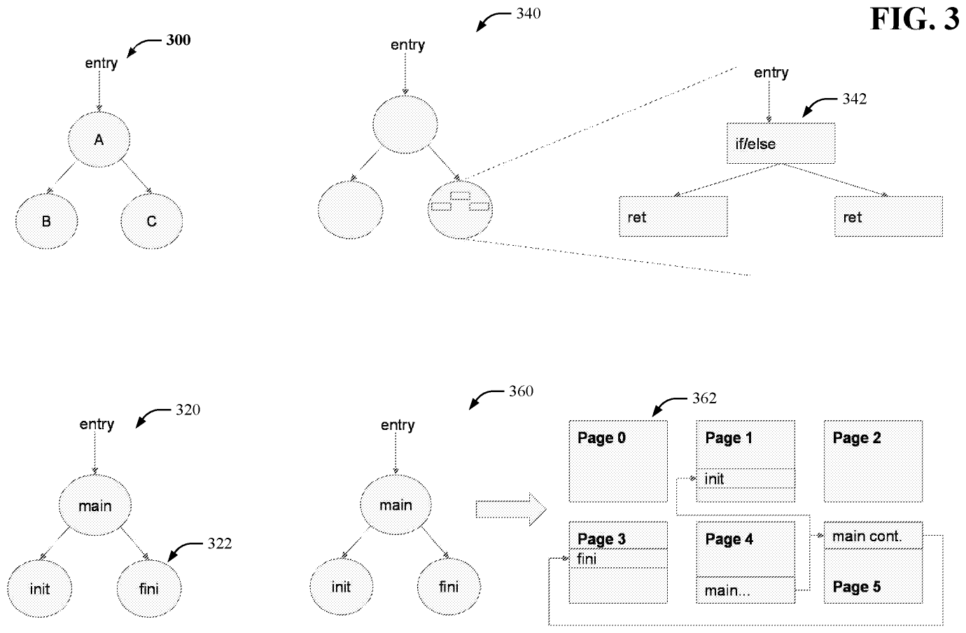

For example, looking briefly to FIG. 3, a set of four diagrams are illustrated. At diagram 300, depicted is a general hierarchy of generic code blocks A, B and C. Code blocks B and C can depend from and/or be comprised by code block A. Any of the code blocks A, B and/or C can be basic data blocks, functions and/or pages (e.g., system pages).

At diagram 320, each node in a callgraph can be a function 322, such as main, init and/or fini in the depicted example. That is, encryption and decryption operations of a system as described herein can function at function granularity.

At diagram 340, one or more functions in a callgraph (e.g., as illustrated at 320) can comprise a control flow graph of basic blocks 342, such as basic data blocks. That is, encryption and decryption operations of a system as described herein can function at basic block granularity.

At diagram 360, it is illustrated that software, such as a program, can be located in memory in one or more system pages 362, such as comprising the one or more functions (e.g., functions 322). That is, encryption and decryption operations of a system as described herein can function at page granularity.

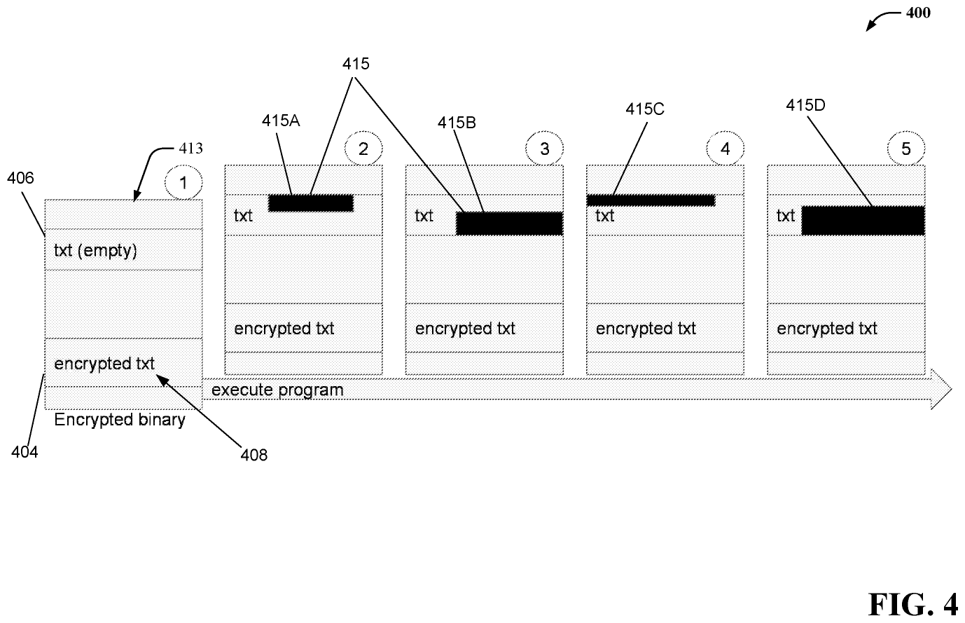

Turning next briefly to FIG. 4, an exemplary depiction of a code block 402 is illustrated at stage 1 of the flow diagram 400. The code block 413, which can be a code block 213 relative to the non-limiting system 200, can have both encrypted code, such as encrypted text (encrypted txt) storage 404 and regular storage 406. The regular storage 406, such as memory, bucket and/or the like, can be a regular text section that can be empty until filled with decrypted code. As will be discussed below, the regular storage 406, such as when not comprising decrypted code, can comprise one or more illegal instructions and/or encrypted code.

Referring back again to FIG. 2, the encryption component 212 can obtain, such as from and/or facilitated by the determination component 210, the code block 213. Such obtaining can include identification and/or locating of the code block 213. The encryption component 212 can encrypt code of the code block 213 into encrypted code 208. Any suitable encryption engine, encryption method, machine learning method, encryption algorithm and/or the like can be employed to encrypt the initial unencrypted code of the code block 213. For example, a block cypher can be employed where a block can be the length of a unit of the code to be encrypted. One or more examples can include, but are not limited to, symmetric and/or asymmetric data encryption standard (DES) and/or Rivest-Shamir-Adleman (RSA) techniques.

In one or more embodiments, code, such as source code, execution code and/or the like can be compiled, such as initially compiled, with encryption performed by the encryption component 212. In one or more embodiments, the encryption, such as at compile time, can result in the encrypted code 208 having a form of encrypted binary.

The decryption component 214 generally can, in response to an indication being received that encrypted code 208 of a code block 213 is to be used, temporarily decrypt the encrypted code 208. The encrypted code 208 can be decrypted into decrypted code 215 for use of the decrypted code 215 in its unencrypted state.

For example, decryption by the decryption component 214 can be triggered by a dynamic interception technique. In one such case, the aforementioned indication can be based on or in response to a trigger marker disposed at or otherwise written with the encrypted code 208. For example, a trigger marker can be written with the encrypted code 208, such as at compile time of the respective code block 213, such as by the encryption component 212. That is, the decryption component 214 can recognize a trigger marker at the encrypted code 208 of the code block 213, where the decryption component 214 can thereby initiate decryption of the encrypted code 208 in response to the recognition. The trigger marker employed can be an instruction to decrypt, an illegal instruction, and/or any other code that can trigger the decryption component 214 once read, such as during runtime execution of the code block 213. That is, the encrypted code 208 can be decrypted on demand, such as employing the trigger markers in a dynamic interception technique. A trigger marker can be employed at any one or more level of a code block, such as at code block level, basic block level, function level and/or page level.

The dynamic interception can be done by way of static compiler instrumentation at any of the aforementioned levels (basic block level, function level and/or page level) of a code block, by way of dynamic instrumentation at any of the aforementioned levels of a code block, and/or by way of exception at any of the aforementioned levels of a code block. Via the exception technique, an exception handler, such as of the decryption component 214, can recognize an illegal instruction (e.g., employed as a trigger marker), and can thereby initiate/trigger decryption of a code block or portion of a code block.

Referring again to FIG. 4, while at rest, the encrypted binary can have an encrypted text section (e.g., encrypted storage 404) and a regular text section (e.g., regular storage 406) can be empty and/or at least partially filled with illegal text (e.g., illegal instructions) and/or encrypted code (e.g., a copy of encrypted code 408). While the code block 413 is executing, the regular text section can be filled with decrypted text 415, such as by decrypting encrypted code 408 (e.g., portions thereof) on demand. That is the decrypted code 415 in the regular text section (e.g., regular storage 406) can grow, shrink and/or otherwise change as a respective software executes. This change in the decrypted code 415 is represented by the different portions 415A, 415B, 415C and 415D that are written to and purged from the regular text section over the course of stages 2 to 5 of the flow diagram 400.

Relative to the purging of decrypted code, reference is again made to FIG. 2, and particularly to the purging component 216. Generally, the purging component 216 can purge the decrypted code 215 from the code block 213 after one or more uses of the decrypted code 215. In one or more embodiments, a frequency of use, number of uses, or overall decrypted time, for example, can be selectively set as a threshold for allowance of the decrypted code 215 to remain at the code block 213. After the threshold is reached, the decrypted code 215 can be purged by the purging component 216. The purging can comprise any one or more of deleting the decrypted code 215 and/or overwriting the decrypted code 215 with any one or more of empty values, illegal instructions, illegal text and/or encrypted code (such as a copy of the encrypted code 208).

Purging can be performed after a code block and/or its dominated blocks (e.g., portions and/or sub-blocks of a code block) complete, before a code block and/or its dominated blocks complete and/or during completion of a code block and/or its dominated blocks. Where purging occurs at least partially before a code block and its dominated blocks complete, any of control flow graph context, callgraph context and/or system page context can be employed. Relative to control flow graph context, in a non-loop case, backward basic blocks up to the entry can be available to purge. In a loop case, backward blocks up to a loop header can be purged, although this can employ re-decryption when a new iteration occurs. Relative to callgraph context, backward functions currently on a stack can be purged, such as up to some value/quantity N, where N>0 and N<stack size. Again, this can employ re-decryption when a new iteration occurs. Relative to system page context (e.g., page context more generally), backward functions currently on the stack can be purged, such as up to some value/quantity N, where N>0 and N<stack size, provided that a page reference count for a given function is 0 after purging. Again, this can employ re-decryption when a new iteration occurs.

Differently, in one or more embodiments, one or more decrypted code can be non-purged, although this can leave the code accessible to mal-intentioned targeting.

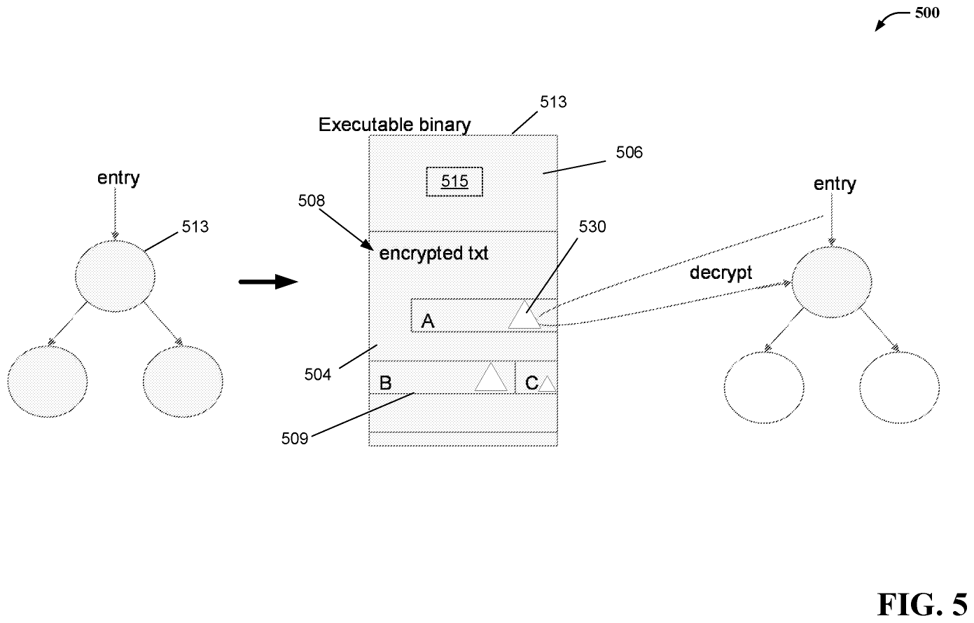

In summary, referring to FIG. 5, one or more code blocks 513 can be encrypted, such as at compile time, such as to comprise encrypted code 508, such as encrypted binary. At runtime, one or more code blocks 513 can be decrypted, such as on command. For example, when code (e.g., encrypted code 508) of a code block 513 is accessed, a trigger marker 530 can be recognized. This recognition can trigger the respective decryption component (e.g., decryption component 214) to decrypt the encrypted text 508 at the encrypted storage 504 of the code block 513. The decryption can comprise writing of decrypted code 515 at the regular storage 506 of the code block 513.

After one or more uses of the decrypted code 515, such as after completion of the code block 513 and of its dominated sub-blocks 509, the decrypted code 515 can be purged. That is, the decrypted code 515 can be purged from the regular storage 506 of the code block 513, such as via a respective purging component (e.g., purging component 216). The purging can comprise any one or more of deletion of the decrypted code 515, overwriting with illegal instruction and/or other text and/or overwriting with a copy of encrypted code 508.

As explained above relative to FIG. 4, different portions of the code block (e.g., the dominated sub-blocks 509) can be decrypted and/or purged simultaneously and or at different times. In one embodiment, each of the sub-blocks 509 A, B and C can be employed in series. As such, when the respective marker 530 for sub-block A triggers decryption of encrypted code 508 of the sub-block A, decrypted code 515 relating to sub-block A can be written, such as to the regular storage 506. Once sub-block A is complete, the decrypted code 515 relating to the encrypted code 508 of sub-block A can be purged. At least partially simultaneously with and/or subsequent to this purging, decrypted code 515 relating to the sub-block B can be written to the regular storage 506. Likewise, once sub-block B is complete, the decrypted code 515 relating to the encrypted code 508 of sub-block B can be purged. At least partially simultaneously with and/or subsequent to this purging, decrypted code 515 relating to the sub-block C can be written to the regular storage 506. Once sub-block C is complete, the decrypted code 515 relating to the encrypted code 508 of sub-block C can be purged.

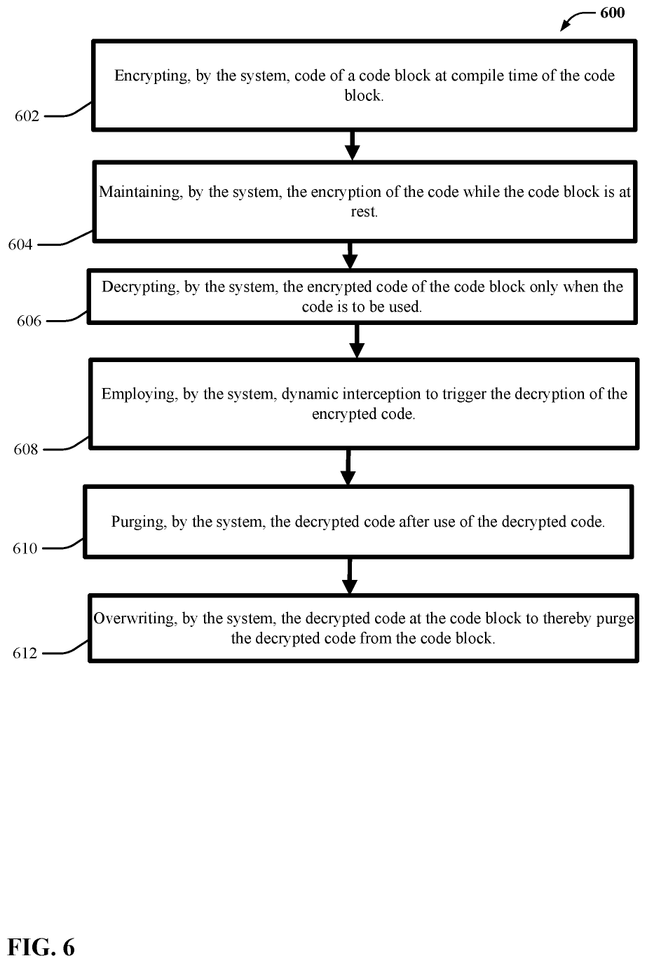

At FIG. 6, illustrated is a flow diagram of an example, non-limiting method 600 that can facilitate a process to encrypt and to temporarily decrypt code of a code block, in accordance with one or more embodiments described herein, such as the non-limiting 200 of FIG. 2. While the non-limiting method 600 is described relative to the non-limiting system 200 of FIG. 2, the non-limiting method 600 can be applicable also to other systems described herein, such as the non-limiting system 100 of FIG. 1. Repetitive description of like elements and/or processes employed in respective embodiments is omitted for sake of brevity.

At 602, the non-limiting method 600 can comprise encrypting, by the system (e.g., encryption component 212 of code encryption and decryption system 202), code of a code block at compile time of the code block.

At 604, the non-limiting method 600 can comprise maintaining, by the system (e.g., code encryption and decryption system 202), the encryption of the code while the code block is at rest.

At 606, the non-limiting method 600 can comprise decrypting, by the system (e.g., decryption component 214 of code encryption and decryption system 202), the encrypted code of the code block only when the code block is to be used.

At 608, the non-limiting method 600 can comprise employing, by the system (e.g., decryption component 214 and encryption component 212 of code encryption and decryption system 202), dynamic interception to trigger the decryption of the encrypted code.

At 610, the non-limiting method 600 can comprise purging, by the system (e.g., purging component 216 of code encryption and decryption system 202), the decrypted code after use of the decrypted code.

At 612, the non-limiting method 600 can comprise overwriting, by the system (e.g., purging component 216 of code encryption and decryption system 202), the decrypted code at the code block to thereby purge the decrypted code from the code block.

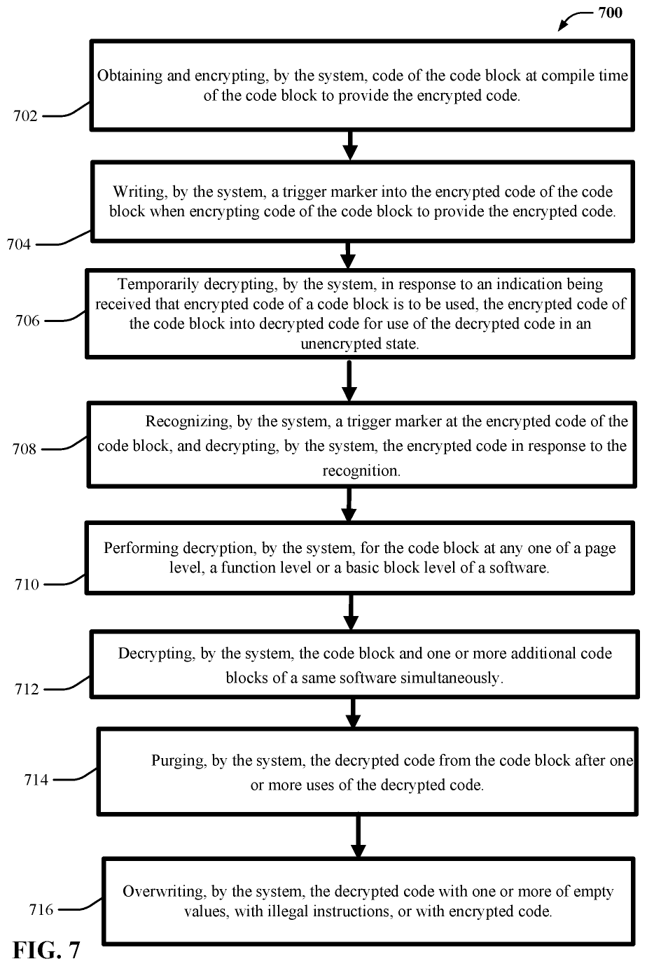

Next, FIG. 7 illustrates a flow diagram of an example, non-limiting method 700 that can facilitate a process to encrypt and to temporarily decrypt code of a code block, in accordance with one or more embodiments described herein, such as the non-limiting 200 of FIG. 2. While the non-limiting method 700 is described relative to the non-limiting system 200 of FIG. 2, the non-limiting method 700 can be applicable also to other systems described herein, such as the non-limiting system 100 of FIG. 1. Repetitive description of like elements and/or processes employed in respective embodiments is omitted for sake of brevity.

At 702, the non-limiting method 700 can comprise obtaining and encrypting, by the system (e.g., encryption component 212 of code encryption and decryption system 202), code of the code block at compile time of the code block to provide the encrypted code.

At 704, the non-limiting method 700 can comprise writing, by the system (e.g., encryption component 212 of code encryption and decryption system 202), a trigger marker into the encrypted code of the code block when encrypting code of the code block to provide the encrypted code.

At 706, the non-limiting method 700 can comprise temporarily decrypting, by the system (e.g., encryption component 212 of code encryption and decryption system 202), in response to an indication being received that encrypted code of a code block is to be used, the encrypted code of the code block into decrypted code for use of the decrypted code in an unencrypted state.

At 708, the non-limiting method 700 can comprise recognizing, by the system (e.g., encryption component 212 of code encryption and decryption system 202), a trigger marker at the encrypted code of the code block, and decrypting, by the system, the encrypted code in response to the recognition.

At 710, the non-limiting method 700 can comprise performing decryption, by the system (e.g., encryption component 212 of code encryption and decryption system 202), for the code block at any one of a page level, a function level or a basic block level of a software.

At 712, the non-limiting method 700 can comprise decrypting, by the system (e.g., encryption component 212 of code encryption and decryption system 202), the code block and one or more additional code blocks of a same software simultaneously.

At 714, the non-limiting method 700 can comprise purging, by the system (e.g., encryption component 212 of code encryption and decryption system 202), the decrypted code from the code block after one or more uses of the decrypted code.

At 716, the non-limiting method 700 can comprise overwriting, by the system (e.g., encryption component 212 of code encryption and decryption system 202), the decrypted code with one or more of empty values, with illegal instructions, or with encrypted code.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, one or more systems, devices, computer program products and/or computer-implemented methods of use provided herein relate to a process to dynamically decrypt code of a software. A system can comprise a memory that stores computer executable components, and a processor that executes the computer executable components stored in the memory, wherein the computer executable components can comprise a decryption component that, in response to an indication being received that encrypted code of a code block is to be used, can temporarily decrypt the encrypted code of the code block into decrypted code for use of the decrypted code in an unencrypted state. In an embodiment, an encryption component can obtain and encrypt code of the code block at compile time of the code block to provide the encrypted code. In an embodiment, an encryption component can write a trigger marker into the encrypted code of the code block when encrypting code of the code block to provide the encrypted code.

An advantage of the aforementioned systems, computer-implemented methods and/or computer program products can be maintaining code in an encrypted state for as long as possible, including when the code is at rest. Only a minimal amount of code is exposed (e.g., decrypted). Indeed, only code blocks to be used can be decoded at a time. In such instances, a full code section can even be decrypted and then purged in parts, such as to limit non-encrypted exposure of the code. This on-demand nature can facilitate assurance that code and/or blocks of code are available in an unencrypted form only when in use. And further, feature lists are not made available for offline study by an attacker.

Another advantage can be provision of the dynamic encryption process absent hardware support. Additional overhead, such as with VM' s is avoided. Indeed, in view of the one or more embodiments described herein, a practical application of the systems, computer-implemented methods and/or computer program products described herein can be dynamic, trigger-based decryption of code and/or code blocks of code in sections only when use is active and/or imminent. Overall, such computerized tools can constitute a concrete and tangible technical improvement in the field of software security.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to model forecasting and/or predictions, as compared to existing systems and/or techniques. Systems, computer-implemented methods and/or computer program products facilitating performance of these processes are of great utility in the field of active computer-based learning and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively digitally encrypt and decrypt code, as the one or more embodiments described herein can facilitate this process. And, neither can the human mind nor a human with pen and paper electronically effectively digitally encrypt and decrypt code, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

Turning next to FIGS. 8-10, a detailed description is provided of additional context for the one or more embodiments described herein at FIGS. 1-7.

FIG. 8 and the following discussion are intended to provide a brief, general description of a suitable operating environment 800 in which one or more embodiments described herein at FIGS. 1-7 can be implemented. For example, one or more components and/or other aspects of embodiments described herein can be implemented in or be associated with, such as accessible via, the operating environment 800. Further, while one or more embodiments have been described above in the general context of computer-executable instructions that can run on one or more computers, those skilled in the art will recognize that one or more embodiments also can be implemented in combination with other program modules and/or as a combination of hardware and software.

Generally, program modules include routines, programs, components, data structures and/or the like, that perform particular tasks and/or implement particular abstract data types. Moreover, the aforedescribed methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and/or the like, each of which can be operatively coupled to one or more associated devices.

Computing devices typically include a variety of media, which can include computer-readable storage media, machine-readable storage media and/or communications media, which two terms are used herein differently from one another as follows. Computer-readable storage media or machine-readable storage media can be any available storage media that can be accessed by the computer and includes both volatile and nonvolatile media, removable and non-removable media. By way of example, but not limitation, computer-readable storage media and/or machine-readable storage media can be implemented in connection with any method or technology for storage of information such as computer-readable and/or machine-readable instructions, program modules, structured data and/or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) and/or other optical disk storage, magnetic cassettes, magnetic tape, magnetic disk storage and/or other magnetic storage devices, solid state drives or other solid state storage devices and/or other tangible and/or non-transitory media which can be used to store specified information. In this regard, the terms “tangible” or “non-transitory” herein as applied to storage, memory and/or computer-readable media, are to be understood to exclude only propagating transitory signals per se as modifiers and do not relinquish rights to all standard storage, memory and/or computer-readable media that are not only propagating transitory signals per se.

Computer-readable storage media can be accessed by one or more local or remote computing devices, e.g., via access requests, queries and/or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set and/or changed in such a manner as to encode information in one or more signals. By way of example, but not limitation, communication media can include wired media, such as a wired network, direct-wired connection and/or wireless media such as acoustic, RF, infrared and/or other wireless media.

With reference still to FIG. 8, the example operating environment 800 for implementing one or more embodiments of the aspects described herein can include a computer 802, the computer 802 including a processing unit 806, a system memory 804 and/or a system bus 808. One or more aspects of the processing unit 806 can be applied to processors such as 106 and/or 206 of the non-limiting systems 100 and/or 200. The processing unit 806 can be implemented in combination with and/or alternatively to processors such as 106 and/or 206.

Memory 804 can store one or more computer and/or machine readable, writable and/or executable components and/or instructions that, when executed by processing unit 806 (e.g., a classical processor, a quantum processor and/or like processor), can facilitate performance of operations defined by the executable component(s) and/or instruction(s). For example, memory 804 can store computer and/or machine readable, writable and/or executable components and/or instructions that, when executed by processing unit 806, can facilitate execution of the one or more functions described herein relating to non-limiting system 100 and/or non-limiting system 200, as described herein with or without reference to the one or more figures of the one or more embodiments.

Memory 804 can comprise volatile memory (e.g., random access memory (RAM), static RAM (SRAM), dynamic RAM (DRAM) and/or the like) and/or non-volatile memory (e.g., read only memory (ROM), programmable ROM (PROM), electrically programmable ROM (EPROM), electrically erasable programmable ROM (EEPROM) and/or the like) that can employ one or more memory architectures.

Processing unit 806 can comprise one or more types of processors and/or electronic circuitry (e.g., a classical processor, a quantum processor and/or like processor) that can implement one or more computer and/or machine readable, writable and/or executable components and/or instructions that can be stored at memory 804. For example, processing unit 806 can perform one or more operations that can be specified by computer and/or machine readable, writable and/or executable components and/or instructions including, but not limited to, logic, control, input/output (I/O), arithmetic and/or the like. In one or more embodiments, processing unit 806 can be any of one or more commercially available processors. In one or more embodiments, processing unit 806 can comprise one or more central processing unit, multi-core processor, microprocessor, dual microprocessors, microcontroller, System on a Chip (SOC), array processor, vector processor, quantum processor and/or another type of processor. The examples of processing unit 806 can be employed to implement one or more embodiments described herein.

The system bus 808 can couple system components including, but not limited to, the system memory 804 to the processing unit 806. The system bus 808 can comprise one or more types of bus structure that can further interconnect to a memory bus (with or without a memory controller), a peripheral bus and/or a local bus using one or more of a variety of commercially available bus architectures. The system memory 804 can include ROM 810 and/or RAM 812. A basic input/output system (BIOS) can be stored in a non-volatile memory such as ROM, erasable programmable read only memory (EPROM) and/or EEPROM, which BIOS contains the basic routines that help to transfer information among elements within the computer 802, such as during startup. The RAM 812 can include a high-speed RAM, such as static RAM for caching data.

The computer 802 can include an internal hard disk drive (HDD) 814 (e.g., EIDE, SATA), one or more external storage devices 816 (e.g., a magnetic floppy disk drive (FDD), a memory stick or flash drive reader, a memory card reader and/or the like) and/or a drive 820, e.g., such as a solid state drive or an optical disk drive, which can read or write from a disk 822, such as a CD-ROM disc, a DVD, a BD and/or the like. Additionally, and/or alternatively, where a solid state drive is involved, disk 822 could not be included, unless separate. While the internal HDD 814 is illustrated as located within the computer 802, the internal HDD 814 can also be configured for external use in a suitable chassis (not shown). Additionally, while not shown in operating environment 800, a solid state drive (SSD) can be used in addition to, or in place of, an HDD 814. The HDD 814, external storage device(s) 816 and drive 820 can be connected to the system bus 808 by an HDD interface 824, an external storage interface 826 and a drive interface 828, respectively. The HDD interface 824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to respective types of storage devices, other types of storage media which are readable by a computer, whether presently existing or developed in the future, can also be used in the example operating environment, and/or that any such storage media can contain computer-executable instructions for performing the methods described herein.

A number of program modules can be stored in the drives and RAM 812, including an operating system 830, one or more applications 832, other program modules 834 and/or program data 836. All or portions of the operating system, applications, modules and/or data can also be cached in the RAM 812. The systems and/or methods described herein can be implemented utilizing one or more commercially available operating systems and/or combinations of operating systems.

Computer 802 can optionally comprise emulation technologies. For example, a hypervisor (not shown) or other intermediary can emulate a hardware environment for operating system 830, and the emulated hardware can optionally be different from the hardware illustrated in FIG. 8. In a related embodiment, operating system 830 can comprise one virtual machine (VM) of multiple VMs hosted at computer 802. Furthermore, operating system 830 can provide runtime environments, such as the JAVA runtime environment or the .NET framework, for applications 832. Runtime environments are consistent execution environments that can allow applications 832 to run on any operating system that includes the runtime environment. Similarly, operating system 830 can support containers, and applications 832 can be in the form of containers, which are lightweight, standalone, executable packages of software that include, e.g., code, runtime, system tools, system libraries and/or settings for an application.

Further, computer 802 can be enabled with a security module, such as a trusted processing module (TPM). For instance, with a TPM, boot components hash next in time boot components and wait for a match of results to secured values before loading a next boot component. This process can take place at any layer in the code execution stack of computer 802, e.g., applied at application execution level and/or at operating system (OS) kernel level, thereby enabling security at any level of code execution.

An entity can enter and/or transmit commands and/or information into the computer 802 through one or more wired/wireless input devices, e.g., a keyboard 838, a touch screen 840 and/or a pointing device, such as a mouse 842. Other input devices (not shown) can include a microphone, an infrared (IR) remote control, a radio frequency (RF) remote control and/or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint and/or iris scanner, and/or the like. These and other input devices can be connected to the processing unit 806 through an input device interface 844 that can be coupled to the system bus 808, but can be connected by other interfaces, such as a parallel port, an IEEE 1394 serial port, a game port, a USB port, an IR interface, a BLUETOOTH® interface and/or the like.

A monitor 846 or other type of display device can be alternatively and/or additionally connected to the system bus 808 via an interface, such as a video adapter 848. In addition to the monitor 846, a computer typically includes other peripheral output devices (not shown), such as speakers, printers and/or the like.

The computer 802 can operate in a networked environment using logical connections via wired and/or wireless communications to one or more remote computers, such as a remote computer(s) 850. The remote computer(s) 850 can be a workstation, a server computer, a router, a personal computer, portable computer, microprocessor-based entertainment appliance, a peer device and/or other common network node, and typically includes many or all of the elements described relative to the computer 802, although, for purposes of brevity, only a memory/storage device 852 is illustrated. Additionally, and/or alternatively, the computer 802 can be coupled (e.g., communicatively, electrically, operatively, optically and/or the like) to one or more external systems, sources and/or devices (e.g., classical and/or quantum computing devices, communication devices and/or like device) via a data cable (e.g., High-Definition Multimedia Interface (HDMI), recommended standard (RS) 232, Ethernet cable and/or the like).

In one or more embodiments, a network can comprise one or more wired and/or wireless networks, including, but not limited to, a cellular network, a wide area network (WAN) (e.g., the Internet), or a local area network (LAN). For example, one or more embodiments described herein can communicate with one or more external systems, sources and/or devices, for instance, computing devices (and vice versa) using virtually any specified wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol and/or other proprietary and/or non-proprietary communication protocols. In a related example, one or more embodiments described herein can include hardware (e.g., a central processing unit (CPU), a transceiver, a decoder, quantum hardware, a quantum processor and/or the like), software (e.g., a set of threads, a set of processes, software in execution, quantum pulse schedule, quantum circuit, quantum gates and/or the like) and/or a combination of hardware and/or software that facilitates communicating information among one or more embodiments described herein and external systems, sources and/or devices (e.g., computing devices, communication devices and/or the like).

The logical connections depicted include wired/wireless connectivity to a local area network (LAN) 854 and/or larger networks, e.g., a wide area network (WAN) 856. LAN and WAN networking environments can be commonplace in offices and companies and can facilitate enterprise-wide computer networks, such as intranets, all of which can connect to a global communications network, e.g., the Internet.

When used in a LAN networking environment, the computer 802 can be connected to the local network 854 through a wired and/or wireless communication network interface or adapter 858. The adapter 858 can facilitate wired and/or wireless communication to the LAN 854, which can also include a wireless access point (AP) disposed thereon for communicating with the adapter 858 in a wireless mode.

When used in a WAN networking environment, the computer 802 can include a modem 860 and/or can be connected to a communications server on the WAN 856 via other means for establishing communications over the WAN 856, such as by way of the Internet. The modem 860, which can be internal and/or external and a wired and/or wireless device, can be connected to the system bus 808 via the input device interface 844. In a networked environment, program modules depicted relative to the computer 802 or portions thereof can be stored in the remote memory/storage device 852. The network connections shown are merely exemplary and one or more other means of establishing a communications link among the computers can be used.

When used in either a LAN or WAN networking environment, the computer 802 can access cloud storage systems or other network-based storage systems in addition to, and/or in place of, external storage devices 816 as described above, such as but not limited to, a network virtual machine providing one or more aspects of storage and/or processing of information. Generally, a connection between the computer 802 and a cloud storage system can be established over a LAN 854 or WAN 856 e.g., by the adapter 858 or modem 860, respectively. Upon connecting the computer 802 to an associated cloud storage system, the external storage interface 826 can, such as with the aid of the adapter 858 and/or modem 860, manage storage provided by the cloud storage system as it would other types of external storage. For instance, the external storage interface 826 can be configured to provide access to cloud storage sources as if those sources were physically connected to the computer 802.

The computer 802 can be operable to communicate with any wireless devices and/or entities operatively disposed in wireless communication, e.g., a printer, scanner, desktop and/or portable computer, portable data assistant, communications satellite, telephone and/or any piece of equipment or location associated with a wirelessly detectable tag (e.g., a kiosk, news stand, store shelf and/or the like). This can include Wireless Fidelity (Wi-Fi) and BLUETOOTH® wireless technologies. Thus, the communication can be a predefined structure as with a conventional network or simply an ad hoc communication between at least two devices.

The illustrated embodiments described herein can be employed relative to distributed computing environments (e.g., cloud computing environments), such as described below with respect to FIG. 13, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment 1950 described below with reference to FIG. 9, and/or with reference to the one or more functional abstraction layers (e.g., quantum software and/or the like) described below with reference to FIG. 10, to execute one or more operations in accordance with one or more embodiments described herein. For example, cloud computing environment 950 and/or one or more of the functional abstraction layers 1060, 1070, 1080 and/or 1090 can comprise one or more classical computing devices (e.g., classical computer, classical processor, virtual machine, server and/or the like), quantum hardware and/or quantum software (e.g., quantum computing device, quantum computer, quantum processor, quantum circuit simulation software, superconducting circuit and/or the like) that can be employed by one or more embodiments described herein and/or components thereof to execute one or more operations in accordance with one or more embodiments described herein. For instance, one or more embodiments described herein and/or components thereof can employ such one or more classical and/or quantum computing resources to execute one or more classical and/or quantum: mathematical function, calculation and/or equation; computing and/or processing script; algorithm; model (e.g., artificial intelligence (AI) model, machine learning (ML) model and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines and/or services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can specify location at a higher level of abstraction (e.g., country, state and/or datacenter).

Rapid elasticity: capabilities can be rapidly and elastically provisioned, in one or more cases automatically, to quickly scale out and rapidly released to quickly scale in. To the consumer, the capabilities available for provisioning can appear to be unlimited and can be purchased in any quantity at any time.

Measured service: cloud systems automatically control and optimize resource use by leveraging a metering capability at one or more levels of abstraction appropriate to the type of service (e.g., storage, processing, bandwidth and/or active user accounts). Resource usage can be monitored, controlled and/or reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage and/or individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems and/or storage, but has control over the deployed applications and possibly application hosting environment configurations.

Infrastructure as a Service (IaaS): the capability provided to the consumer is to provision processing, storage, networks and/or other fundamental computing resources where the consumer can deploy and run arbitrary software, which can include operating systems and applications. The consumer does not manage or control the underlying cloud infrastructure but has control over operating systems, storage, deployed applications and/or possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy and/or compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community or public) that remain unique entities but are bound together by standardized or proprietary technology that enables data and application portability (e.g., cloud bursting for load-balancing among clouds).

A cloud computing environment is service oriented with a focus on statelessness, low coupling, modularity and/or semantic interoperability. At the heart of cloud computing is an infrastructure that includes a network of interconnected nodes.

Moreover, the non-limiting system 100 and/or the example operating environment 800 can be associated with and/or be included in a data analytics system, a data processing system, a graph analytics system, a graph processing system, a big data system, a social network system, a speech recognition system, an image recognition system, a graphical modeling system, a bioinformatics system, a data compression system, an artificial intelligence system, an authentication system, a syntactic pattern recognition system, a medical system, a health monitoring system, a network system, a computer network system, a communication system, a router system, a server system, a high availability server system (e.g., a Telecom server system), a Web server system, a file server system, a data server system, a disk array system, a powered insertion board system, a cloud-based system and/or the like. In accordance therewith, non-limiting system 100 and/or example operating environment 800 can be employed to use hardware and/or software to solve problems that are highly technical in nature, that are not abstract and/or that cannot be performed as a set of mental acts by a human.

Referring now to details of one or more aspects illustrated at FIG. 9, the illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C and/or automobile computer system 954N can communicate. Although not illustrated in FIG. 9, cloud computing nodes 910 can further comprise a quantum platform (e.g., quantum computer, quantum hardware, quantum software and/or the like) with which local computing devices used by cloud consumers can communicate. Cloud computing nodes 910 can communicate with one another. They can be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that cloud computing nodes 910 and cloud computing environment 950 can communicate with any type of computerized device over any type of network and/or network addressable connection (e.g., using a web browser).

Referring now to details of one or more aspects illustrated at FIG. 10, a set 1000 of functional abstraction layers is shown, such as provided by cloud computing environment 950 (FIG. 19). One or more embodiments described herein can be associated with, such as accessible via, one or more functional abstraction layers described below with reference to FIG. 10 (e.g., hardware and software layer 1060, virtualization layer 1070, management layer 1080 and/or workloads layer 1090). It should be understood in advance that the components, layers and/or functions shown in FIG. 10 are intended to be illustrative only and embodiments described herein are not limited thereto. As depicted, the following layers and/or corresponding functions are provided:

Hardware and software layer 1060 can include hardware and software components. Examples of hardware components include: mainframes 1061; RISC (Reduced Instruction Set Computer) architecture-based servers 1062; servers 1063; blade servers 1064; storage devices 1065; and/or networks and/or networking components 1066. In one or more embodiments, software components can include network application server software 1067, quantum platform routing software 1068; and/or quantum software (not illustrated in FIG. 10).

Virtualization layer 1070 can provide an abstraction layer from which the following examples of virtual entities can be provided: virtual servers 1071; virtual storage 1072; virtual networks 1073, including virtual private networks; virtual applications and/or operating systems 1074; and/or virtual clients 1075.

In one example, management layer 1080 can provide the functions described below. Resource provisioning 1081 can provide dynamic procurement of computing resources and other resources that can be utilized to perform tasks within the cloud computing environment. Metering and Pricing 1082 can provide cost tracking as resources are utilized within the cloud computing environment, and/or billing and/or invoicing for consumption of these resources. In one example, these resources can include one or more application software licenses. Security can provide identity verification for cloud consumers and/or tasks, as well as protection for data and/or other resources. User (or entity) portal 1083 can provide access to the cloud computing environment for consumers and system administrators. Service level management 1084 can provide cloud computing resource allocation and/or management such that required service levels are met. Service Level Agreement (SLA) planning and fulfillment 1085 can provide pre-arrangement for, and procurement of, cloud computing resources for which a future requirement is anticipated in accordance with an SLA.

Workloads layer 1090 can provide examples of functionality for which the cloud computing environment can be utilized. Non-limiting examples of workloads and functions which can be provided from this layer include: mapping and navigation 1091; software development and lifecycle management 1092; virtual classroom education delivery 1093; data analytics processing 1094; transaction processing 1095; and/or application transformation software 1096.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a decryption component that, in response to an indication being received that encrypted code of a code block is to be used, temporarily decrypts the encrypted code of the code block into decrypted code for use of the decrypted code in an unencrypted state.

2. The system of claim 1, further comprising:
an encryption component that obtains and encrypts code of the code block at compile time of the code block to provide the encrypted code.

3. The system of claim 1, further comprising:
an encryption component that writes a trigger marker into the encrypted code of the code block when encrypting code of the code block to provide the encrypted code.

4. The system of claim 1, wherein the decryption component recognizes a trigger marker at the encrypted code of the code block, and wherein the decryption component initiates decryption of the encrypted code in response to the recognition.

5. The system of claim 1, further comprising:
a purging component that purges the decrypted code from the code block after one or more uses of the decrypted code.

6. The system of claim 5, wherein the purging component overwrites the decrypted code with one or more of empty values, with illegal instructions, or with encrypted code.

7. The system of claim 1, wherein the decryption is performed for the code block at any one of a page level, a function level or a basic block level of a software.

8. The system of claim 1, wherein the decryption component decrypts the code block and one or more additional code blocks of a same software simultaneously.

9. A computer-implemented method, comprising:
temporarily decrypting, by a system operatively coupled to a processor, in response to an indication being received that encrypted code of a code block is to be used, the encrypted code of the code block into decrypted code for use of the decrypted code in an unencrypted state.

10. The computer-implemented method of claim 9, further comprising:
obtaining and encrypting, by the system, code of the code block at compile time of the code block to provide the encrypted code.

11. The computer-implemented method of claim 9, further comprising:
writing, by the system, a trigger marker into the encrypted code of the code block when encrypting code of the code block to provide the encrypted code.

12. The computer-implemented method of claim 9, further comprising:
recognizing, by the system, a trigger marker at the encrypted code of the code block; and
decrypting, by the system, the encrypted code in response to the recognition.

13. The computer-implemented method of claim 9, further comprising:
purging, by the system, the decrypted code from the code block after one or more uses of the decrypted code.

14. The computer-implemented method of claim 13, wherein the purging comprises:
overwriting, by the system, the decrypted code with one or more of empty values, with illegal instructions, or with encrypted code.

15. A computer program product facilitating a process to dynamically decrypt code, the computer program product comprising a computer readable storage medium having program instructions embodied therewith, the program instructions executable by a processor to cause the processor to:
temporarily decrypt, by the processor, in response to an indication being received that encrypted code of a code block is to be used, the encrypted code of the code block into decrypted code for use of the decrypted code in an unencrypted state.

16. The computer program product of claim 15, wherein the program instructions are further executable by the processor to cause the processor to:
obtain and encrypt, by the processor, code of the code block at compile time of the code block to provide the encrypted code.

17. The computer program product of claim 15, wherein the program instructions are further executable by the processor to cause the processor to:
write, by the processor, a trigger marker into the encrypted code of the code block when encrypting code of the code block to provide the encrypted code.

18. The computer program product of claim 15, wherein the program instructions are further executable by the processor to cause the processor to:
recognize, by the processor, a trigger marker at the encrypted code of the code block; and
decrypt, by the processor, the encrypted code in response to the recognition.

19. The computer program product of claim 15, wherein the program instructions are further executable by the processor to cause the processor to:
purge, by the processor, the decrypted code from the code block after one or more uses of the decrypted code.

20. The computer program product of claim 19, wherein the purging further comprises execution of one or more program instructions by the processor to cause the processor to:
overwrite, by the processor, the decrypted code with one or more of empty values, with illegal instructions, or with encrypted code.
